(19) United States
(12) Patent Application Publication
(10) Pub. No.: US 2021/0061250 A1
(43) Pub. Date: Mar. 4, 2021

(54) HYBRID VEHICLE

(71) Applicant: TOYOTA JIDOSHA KABUSHIKI KAISHA, Toyota-shi, Aichi (JP)

(72) Inventors: Kenji ITAGAKI, Sunto-gun, Shizuoka-ken (JP); Taro MOTEKI, Susono-shi, Shizuoka-ken (JP); Koichi KATO, Susono-shi, Shizuoka-ken (JP)

(73) Assignee: TOYOTA JIDOSHA KABUSHIKI KAISHA, Toyota-shi, Aichi (JP)

(21) Appl. No.: 16/963,614

(22) PCT Filed: Dec. 25, 2018
(86) PCT No.: PCT/JP2018/047675

§ 371 Date: Jul. 21, 2020

(30) Foreign Application Priority Data
Jan. 26, 2018 (JP) 2018-011714

(51) Int. Cl. B60W 20/10; B60W 10/06; B60W 10/08; B60K 6/442

(52) U.S. Cl. CPC B60W 20/10; B60W 10/06; B60W 10/08; B60K 6/442; B60W 2710/083; B60W 2510/0657; B60W 2510/0638; B60W 2710/0666; B60W 2710/0661

(57) ABSTRACT

A hybrid vehicle includes an engine; an output member, a rotary electric machine; and a power dividing mechanism including an input element coupled to the engine, a reaction force element coupled to the rotary electric machine, and an output element coupled to the output member. Further, the rotary electric machine is provided such that, in order that a torque corresponding to required engine torque based on an acceleration request is applied to the drive wheel, a reaction torque corresponding to the required engine torque is output, the reaction torque of the rotary electric machine is output when an engine speed is equal to or higher than a predetermined value, and, when the engine speed is lower than the predetermined value, an engine speed increase rate is maximized regardless of an accelerator opening degree.

### FIELD

The present invention relates to a hybrid vehicle.

### BACKGROUND

Patent Document 1 discloses a hybrid vehicle that generates output torque on an output shaft by outputting reaction torque of a motor generator at the timing of approaching the target value of the engine speed.

### CITATION LIST

### Patent Literature

Patent Literature 1: JP 2005-184999A

### SUMMARY

### Technical Problems

In a hybrid vehicle, when the accelerator is depressed halfway, the required output to the engine decreases as compared to when the accelerator is fully open. Normally, as the engine required output increases, an engine speed increase rate also increases in order to secure acceleration response. Therefore, when the accelerator is depressed halfway, the engine speed increase rate becomes lower than that when the accelerator is fully open, resulting in an increase in time required for the engine speed to reach the target value (time required for the engine speed increase control to be completed) at which the reaction torque of the motor generator is output. As a result, the acceleration response may deteriorate.

The present invention has been made in view of the foregoing problems, and an object of the present invention is to provide a hybrid vehicle that can improve acceleration response when the accelerator is depressed halfway.

### Solution to Problem

To resolve the above problem and attain the object, a hybrid vehicle according to the present invention includes: an engine; an output member that transmits drive power to a drive wheel; a rotary electric machine; and a power dividing mechanism by which drive power output by the engine is transmitted so as to be divided into a drive power for the output member and a drive power for the rotary electric machine, wherein the power dividing mechanism includes at least three rotary elements, which are an input element coupled to the engine, a reaction force element coupled to the rotary electric machine, and an output element coupled to the output member; the rotary electric machine is configured such that, in order that a torque corresponding to required engine torque based on an acceleration request is applied to the drive wheel, a reaction torque corresponding to the required engine torque can be output, and the reaction torque of the rotary electric machine is output when an engine speed is equal to or higher than a predetermined value, the hybrid vehicle characterized in that, when the engine speed is lower than the predetermined value, an engine speed increase rate is maximized regardless of an accelerator opening degree.

Further, the engine may be equipped with a supercharger and the hybrid vehicle may increase an output torque of the engine by actuating the supercharger.

Thus, the engine speed can be quickly increased in order to rotate the turbine of a supercharger.

### Advantageous Effects of the Invention

Accordingly, the hybrid vehicle according to the present invention has an advantageous effect in that engine speed increase control with an accelerator depressed halfway can be completed earlier than the case where an engine speed increase rate with the accelerator depressed halfway is smaller than that with the accelerator fully open, thus making it possible to improve acceleration response when the accelerator is depressed halfway.

### BRIEF DESCRIPTION OF DRAWINGS

FIG. 1 is a skeleton diagram illustrating an example of a power train of a hybrid vehicle.

FIG. 2 is a collinear diagram of a power dividing mechanism 4 including a single-pinion type planetary gear mechanism in FIG. 1.

FIG. 3 is a flowchart illustrating an example of control executed by an ECU, with an accelerator depressed halfway.

FIG. 4 is a time chart illustrating an example of accelerator opening degree, engine required output, engine speed, and drive power.

### DESCRIPTION OF EMBODIMENT

An embodiment of a hybrid vehicle according to the present invention will be described below. Note that the present invention is not limited by the embodiment.

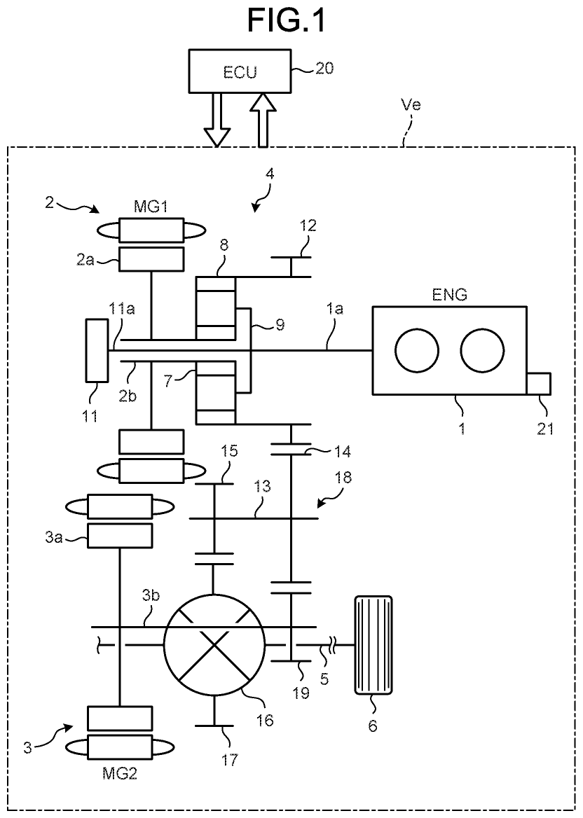

FIG. 1 is a skeleton diagram illustrating an example of a power train of a hybrid vehicle Ve. The hybrid vehicle Ve includes: an engine (ENG) 1 as a main prime mover; and a plurality of drive power sources, which are a first motor generator (MG1) 2 as a rotary electric machine and a second motor generator (MG2) 3 as a rotary electric machine. The hybrid vehicle Ve is configured such that a power dividing mechanism 4 divides power output from the engine 1 into power on a first motor generator 2 side and power on a drive shaft 5 side to be transmitted. Power generated by the first motor generator 2 can be supplied to the second motor generator 3, and drive power output by the second motor generator 3 can be added to a drive shaft 5 and a drive wheel 6.

Each of the first motor generator 2 and the second motor generator 3 has a function as a motor that outputs torque by its being supplied with drive electric power, and a function as a generator that generates electric power by its being supplied with torque. (a power generation function). Note that the first motor generator 2 and the second motor generator 3 are electrically coupled to a power storage devices, such as a battery or a capacitor, via an inverter or the like (not illustrated) and are configured such that electric power is supplied from the power storage device and generated electric power is charged into the power storage device.

The power dividing mechanism 4 is disposed on the same axis as the engine 1 and the first motor generator 2. An output shaft 1a of the engine 1 is coupled to a carrier 9 that is an input element of a planetary gear mechanism composing the power dividing mechanism 4. The output shaft 1a serves as an input shaft for the power dividing mechanism 4 in a power transmission path from the engine 1 to the drive wheel 6. Coupled to the carrier 9 is a rotation shaft 11a of an oil pump 11 that supplies oil for lubricating and cooling the power dividing mechanism 4 and for cooling heat generated by copper loss and iron loss of the first motor generator 2 and the second motor generator 3.

The first motor generator 2 is disposed adjacent to the power dividing mechanism 4 and on the side opposite to the engine 1, and a rotor shaft 2b that rotates integrally with a rotor 2a of the first motor generator 2 is coupled to a sun gear 7, which is a reaction force element for the planetary gear mechanism. The rotor shaft 2b and the rotation shaft of the sun gear 7 are hollow shafts, and the rotation shaft 11a of the oil pump 11 is disposed in the respective hollow portions of the rotor shaft 2b and the rotation shaft of the sun gear 7. The rotation shaft 11a is coupled to the output shaft 1a of the engine 1 through the hollow portions.

On the outer peripheral portion of a ring gear 8 of the planetary gear mechanism, a first drive gear 12 of an external gear as an output member is formed integrally with the ring gear 8 as an output element. In addition, a counter shaft 13 is disposed in parallel with the rotation axis of the power dividing mechanism 4 and first motor generator 2. A counter driven gear 14 meshing with the first drive gear 12 is attached to one end of the counter shaft 13 so as to rotate integrally therewith. The counter driven gear 14 is configured to amplify torque transmitted from the first drive gear 12. Meanwhile, a counter drive gear 15 is attached to the other end of the counter shaft 13 so as to rotate integrally with the counter shaft 13. The counter drive gear 15 meshes with a differential ring gear 17 of a differential gear 16. Therefore, the ring gear 8 of the power dividing mechanism 4 is coupled to the drive shaft 5 and the drive wheel 6 so that power can be transmitted via an output gear train 18 including the first drive gear 12, the counter shaft 13, the counter driven gear 14, the counter drive gear 15, and the differential ring gear 17.

The power train of the hybrid vehicle Ve is configured such that torque output from the second motor generator 3 can be added to torque transmitted from the power dividing mechanism 4 to the drive shaft 5 and the drive wheel 6. Specifically, a rotor shaft 3b that rotates integrally with a rotor 3a of the second motor generator 3 is disposed in parallel with the counter shaft 13. A second drive gear 19 that meshes with the counter driven gear 14 is attached to the tip of the rotor shaft 3b so as to rotate integrally therewith. Therefore, the second motor generator 3 is coupled to the ring gear 8 of the power dividing mechanism 4 via the differential ring gear 17 and the second drive gear 19 so that power can be transmitted. That is, together with the second motor generator 3, the ring gear 8 is coupled to the drive shaft 5 and the drive wheel 6 via the differential ring gear 17.

The hybrid vehicle Ve allows travel modes such as a hybrid travel mode (HV travel) mainly using the engine 1 as a power source and an electric travel mode (EV travel) in which the first motor generator 2 and the second motor generator 3 are driven by the electric power of the power storage device. Such setting and switching of each travel mode are executed by an ECU (Electronic Control Unit) 20. The ECU 20 is electrically connected to the engine 1, the first motor generator 2, the second motor generator 3, etc. so as to transmit a control command signal. The ECU 20 is composed of a microcomputer as a main component, performs an arithmetic operation using input data as well as data and a program stored in advance, and is configured to output a result of the arithmetic operation as a control command signal. The data input to the ECU 20 include, for example, a vehicle speed, a wheel speed, an accelerator opening degree, and a quantity of remaining charge (SOC) of the power storage device. The data stored in the ECU 20 in advance include, for example, a map in which each of travel modes has been determined, a map in which the optimal fuel consumption operating point for the engine 1 has been determined, and a map in which required power Pe_req (engine required output) for the engine 1 has been determined. The ECU 20 outputs, as control command signals, for example, start and stop command signals for the engine 1, a torque command signal for the first motor generator 2, a torque command signal for the second motor generator 3, and a torque command signal for the engine 1.

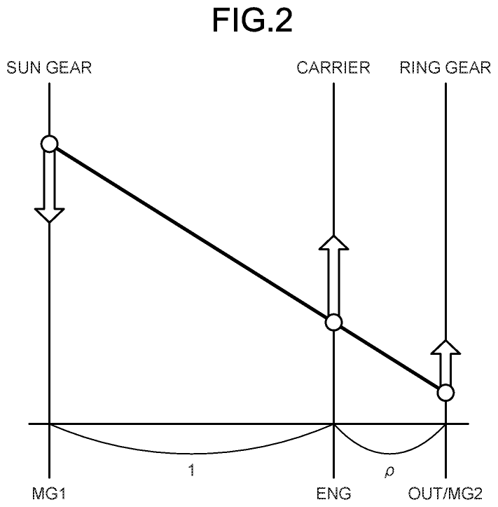

FIG. 2 is a collinear diagram of a power dividing mechanism 4 composed of the single pinion type planetary gear mechanism in FIG. 1. In the collinear diagram illustrated in FIG. 2, a vertical line (an engine shaft) indicating the carrier 9 is provided between a vertical line (a first motor generator shaft) indicating the sun gear 7 and a vertical line (a second motor generator shaft and the output shaft) indicating the ring gear 8. If the interval between the vertical line indicating the sun gear 7 and the vertical line indicating the carrier 9 is “1”, the interval between the vertical line indicating the carrier 9 and the vertical line indicating the ring gear 8 is set to an interval equivalent to a gear ratio ρ. The gear ratio ρ is the ratio between the number of teeth of the sun gear 7 and the number of teeth of the ring gear 8 in the planetary gear mechanism composing the power dividing mechanism 4. A distance from a base line on the line indicating each of the rotary elements indicates the number of rotations of each rotary element, and a line connecting the points indicating the respective numbers of rotations of the rotary elements is a straight line. Note that the arrows in FIG. 2 indicate the respective directions of the torque of the rotary elements.

The collinear diagram illustrated in FIG. 2 indicates an operation state in the hybrid travel mode. In the hybrid travel mode, the vehicle travels mainly using the power of the engine 1. That is, the engine 1 outputs required engine torque Te_req matching required drive power. In that case, the first motor generator 2 functions as a generator, outputs torque in the opposite direction (the direction of negative rotation) to the direction of rotation of the engine 1, and functions as a reaction receiver that supports the reaction of the required engine torque Te_req.

The relationship between the maximum torque Te_max that can be output from the engine 1 and the maximum torque Tg_max that can be output from the first motor generator 2, in the power train illustrated in FIG. 1, is determined such that torque applied to the carrier 9 when the maximum torque Te_max that can be output from the engine 1 in order to increase the engine speed Ne on the basis of an acceleration request, is larger than torque applied to the carrier 9 when the maximum torque Tg_max that can be output from the first motor generator 2 in order to increase the engine speed Ne on the basis of the acceleration request. The relationship between the maximum torque Te_max of the engine 1 and the maximum torque Tg_max of the first motor generator 2 can be represented by the following mathematical expression (1) if the gear ratio ρ is taken into consideration.

Te_max>−{(1+ρ)/ρ}×Tg_max (1)

A torque increase for increasing output torque of the engine 1 is carried out by, for example, a supercharger 21. As the supercharger 21, a mechanical supercharger (supercharger) driven by the power of the output shaft 1a of the engine 1 or an exhaust type supercharger (turbocharger) driven by the kinetic energy of exhaust gas can be used.

The hybrid travel mode in the hybrid vehicle Ve is a travel mode in which the hybrid vehicle Ve is caused to travel mainly by using the engine 1 as a power source as described above. Specifically, by coupling the engine 1 and the power dividing mechanism 4, power output from the engine 1 can be transmitted to the drive wheel 6. To transmit the power output from the engine 1 to the drive wheel 6, as described above, reaction from the first motor generator 2 is applied to the power dividing mechanism 4. Therefore, the sun gear 7 in the power dividing mechanism 4 is caused to function as a reaction force element so that torque output from the engine 1 can be transmitted to the drive wheel 6. That is, the first motor generator 2 outputs reaction torque for required engine torque Te_req in order that torque corresponding to the required engine torque Te_req based on an acceleration request is applied to the drive wheel 6.

In addition, the first motor generator 2 can be arbitrarily controlled in the number of revolutions in accordance with the value of supplied electrical current and the frequency thereof. Therefore, the engine speed Ne can be arbitrarily controlled by controlling the number of revolutions of the first motor generator 2. Specifically, required drive power is determined according to an accelerator opening degree, a vehicle speed, and so on, which are determined by an amount of driver's depression on the accelerator pedal. Further, required power Pe_req of the engine 1 is determined based on the required drive power. In addition, required engine torque Te_req required by the driver is obtained from the required power Pe_req of the engine 1 and the current engine speed Ne. Then, an operating point for the engine 1 is determined from an optimum fuel efficiency line at which the engine 1 has satisfactory fuel efficiency. In addition, the number of revolutions of the first motor generator 2 is controlled so as to obtain the operating point for the engine 1, determined as described above. That is, according to torque transmitted from the engine 1 to the power dividing mechanism 4, the torque Tg or the number of revolutions of the first motor generator 2 is controlled. Specifically, the number of revolutions of the first motor generator 2 is controlled such that the engine speed Ne is controlled to have a target engine speed Ne_req. In this case, because the number of revolutions of the first motor generator 2 can be continuously changed, the engine speed Ne can also be continuously changed.

As described above, the engine speed Ne is controlled by the first motor generator 2, and the torque Tg of the first motor generator 2 is controlled according to the required engine torque Te_req. In that case, the first motor generator 2 functions as a reaction force element as described above. In addition, control of the engine speed Ne requires inertia torque Tg_iner for increasing the engine speed Ne through, for example, an acceleration request. In this case, the inertia torque Tg_iner is a positive value (Tg_iner>0). Specifically, the engine speed Ne is increased while the current actual engine speed Ne is lower than the target engine speed Ne_req. Then, the inertia torque Tg_iner is covered by any one of the drive power sources of the engine 1, the first motor generator 2, and the second motor generator 3.

For example, in the case of steady running or a request for smooth acceleration, the first motor generator 2 controls the engine speed Ne as described above. That is, the first motor generator 2 outputs inertia torque Tg_iner for maintaining or smoothly increasing the engine speed Ne. Therefore, the torque Tg output from the first motor generator 2 can be represented by the following expression (2).

Tg=−{ρ/(1+ρ)}×Te_req+Tg_iner (2)

Note that “−{ρ/(1+ρ)}×T_req” in the above expression (2) indicates the reaction torque described above. Furthermore, the relationship between the respective torques of the rotary elements in the planetary gear mechanism composing the power dividing mechanism 4 described above is determined based on the gear ratio ρ (the ratio between the number of teeth of the sun gear 7 and the number of teeth of the ring gear 8). Therefore, the torque Tg output by the first motor generator 2 can be obtained using the above expression (2).

Meanwhile, in a case where comparative acceleration request is high, such as sudden acceleration, as described above, inertia torque Tg_iner required to increase the engine speed Ne increases. Therefore, when the engine speed Ne is controlled by the first motor generator 2 as described above, the required engine torque Te_req is not output from the drive wheel 6, with the result that the driver may not be able to obtain a feeling of acceleration intended by the driver. Therefore, in the present embodiment, when an acceleration request such as sudden acceleration is high, inertia torque Te_iner for increasing the engine speed Ne, in addition to the required engine torque Te_req, is also output by the engine 1. This inertia torque Te_iner is inertia torque converted into the shaft torque of the engine 1 and is converted by the following expression (3), from the relationship with the gear ratio ρ of the planetary gear mechanism composing the power dividing mechanism 4.

Te_iner={(1+ρ)/ρ}×Tg_iner (3)

Therefore, in the description below, inertia torque output by the engine 1 is indicated as “inert torque Te_iner”, and that output by the first motor generator 2 is indicated as “inert torque Tg_iner”.

The relationship between the maximum torque Te_max that can be output from the engine 1 and the maximum torque Tg_max that can be output from the first motor generator 2, in the power train illustrated in FIG. 1, is determined such that torque applied to the carrier 9 when the maximum torque Te_max that can be output from the engine 1 in order to increase the engine speed Ne on the basis of an acceleration request, is larger than torque applied to the carrier 9 when the maximum torque Tg_max that can be output from the first motor generator 2 in order to increase the engine speed Ne on the basis of the acceleration request. That is, in the present embodiment, as described above, when an acceleration request such as sudden acceleration is high, the required engine torque Te_req and the inertia torque Te_iner are output by the engine 1. Therefore, the maximum torque Te_max of the engine 1 is configured such that at least torque in which inertia torque Te_iner is added to the maximum torque Tg_max that can be output by the first motor generator 2.

The relationship between the maximum torque Te_max of the engine 1 and the maximum torque Tg_max of the first motor generator 2 can be represented by the following mathematical expression (4), in which the gear ratio ρ is taken into consideration.

Te_max>−{(1+ρ)/ρ}×Tg_max (4)

A torque increase for increasing output torque of the engine 1 is carried out by, for example, the supercharger 21. As the supercharger 21, a mechanical supercharger (supercharger) driven by the power of the output shaft la of the engine 1 or an exhaust type supercharger (turbocharger) driven by the kinetic energy of exhaust gas can be used.

Next will be described an example of control executed by the ECU 20 in order to calculate engine torque Te_cmd that is actually given to the engine 1 as a command.

First, the ECU 20 obtains required power Pe_req for the engine 1. The required power Pe_req for the engine 1 is obtained from the required drive power obtained based on an accelerator opening degree and a vehicle speed, which are determined by an amount of driver's depression on the accelerator pedal, and is determined, for example, by referring to a prepared map or the like.

Next, the ECU 20 obtains required engine torque Te_req. The required engine torque Te_req is, for example, engine torque required by the driver and is a value obtained based on, for example, an amount of driver's operation of the accelerator pedal. Therefore, it can be obtained from the required drive power and the current engine speed Ne.

Next, the ECU 20 calculates an inertia torque Tg_iner. As described above, this inertia torque Tg_iner is torque required to increase the engine speed Ne based on the acceleration request and, specifically, it is torque required to change the respective numbers of revolutions of the engine 1 and the first motor generator 2. The calculation of this inertia torque Tg_iner can be obtained by feedback control and feedforward control. In the feedback control, it is obtained based on the difference between the actual engine speed Ne in the current routine and the target engine speed Ne_req in the current routine. In the feedforward control, it is obtained based on a difference between the target engine speed Ne_req of the current routine and the target engine speed Ne_req+1 after one routine. That is, the inertia torque Tg_iner can be obtained from the feedback torque Tg_fb in the feedback control and the feedforward torque Tg_ff in the feedforward control. Therefore, the inertia torque Tg_iner can be represented by the following expression (5).

Tg_iner=Tg_fb+Tg_ff (5)

Note that the feedforward torque Tg_ff is obtained by multiplying an increase dNe of the target engine speed Ne_req to be increased during one routine, and the inertia moment Ie of the engine 1 and first motor generator 2, and by further multiplying a conversion coefficient K for converting the shaft torque of the engine 1 into the shaft torque of the first motor generator 2. This can be simply represented by the following expression (6).

Tg_ff=Ie×K×dNe/dt (6)

In the above expression (5), the influence of the second motor generator 3 on rotation fluctuation of the rotation shaft is relatively small and, therefore, it is not considered.

Next, it is determined whether the calculated inertia torque Tg_iner is larger than a preset threshold α or not. As described above, this is for determining whether the inertia torque Tg_iner when the engine speed Ne is controlled by the first motor generator 2 is larger than the threshold α or not. In other words, it is determined whether a comparative acceleration request such as sudden acceleration is high or not. Therefore, the threshold α is set to, for example, the value of the inertia torque Tg_iner required to increase the rate of change of the engine speed Ne. The threshold α is not limited to the case where a comparative acceleration request such as sudden acceleration is high and may be applied to the case where there is at least an acceleration request regardless of the magnitude of the acceleration request and the engine speed Ne is increased. Therefore, the threshold value α is appropriately set according to the magnitude of the acceleration request, each type of vehicle, etc, and the value of the threshold value α is set to at least 0 or larger.

If the value of the inertia torque Tg_iner is larger than the threshold α due to, for example, a large change rate of the engine speed Ne, the engine torque Te_cmd actually given to the engine 1 as a command is the total torque in which inertia torque Te_iner converted into the engine shaft is added to the required engine torque Te_req. Therefore, the engine torque Te_cmd actually given to the engine 1 as a command is simply expressed by the following expression (7).

Te_cmd=Te_req+Te_iner (7)

Meanwhile, if the value of the inertia torque Tg_iner is equal to or smaller than the threshold α, the engine torque Te_cmd actually given to the engine 1 as a command is the required engine torque Te_req. Therefore, the engine torque Te_cmd that is actually given to the engine 1 as a command can be represented by the following expression (8).

Te_cmd=Te_req (8)

Note that the control described is repeatedly executed, for example, every predetermined time, and the one routine corresponds to a “predetermined time”.

Here, during acceleration in which the accelerator is depressed halfway (partial acceleration), the engine required output decreases as compared to during acceleration in which the accelerator is fully open (an accelerator opening degree of 100%). Therefore, when the engine speed Ne is increased at the initial stage of acceleration in order to make the engine output earlier during acceleration in which the accelerator is depressed halfway (partial acceleration), the engine torque Te decreases as compared to during acceleration in which the accelerator is fully open. Consequently, an engine speed increase time taken for the engine speed Ne to reach a target value at which the reaction torque of the first motor generator 2 is output (i.e., taken to complete the engine speed increase control in which the engine speed Ne is increased to an increased target speed) becomes longer, resulting in deterioration in acceleration response (drive power output response).

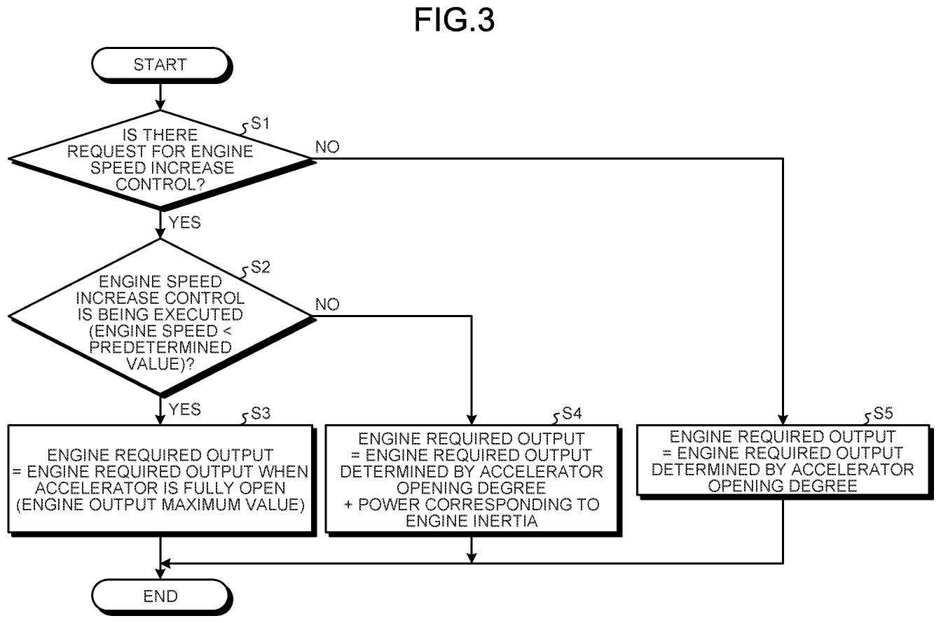

FIG. 3 is a flowchart illustrating an example of control executed by the ECU 20, with the accelerator depressed halfway.

First, the ECU 20 determines whether there is a request for engine speed increase control (step S1). If there is no request for the engine speed increase control (No in Step S1), the ECU 20 sets an engine required output determined by an engine required output=an accelerator opening degree (Step S5), and ends a series of controls.

Conversely, if there is a request for the engine speed increase control (Yes in step S1), the ECU 20 determines whether the engine speed increase control is being executed (the engine speed<a predetermined value) (step S2). If the engine speed increase control is being executed (the engine speed<the predetermined value) (Yes in step S2), the ECU 20 sets an engine required output (the engine output maximum value) determined by an engine required output=an engine required output when the accelerator is fully open (step S3), and ends the series of controls.

Conversely, if the engine speed increase control is not being executed (the engine speed<the predetermined value) (No in step S2), the ECU 20 sets an engine required output=an engine required output determined by an accelerator opening degree+power corresponding to engine inertia (Step S4), and ends the series of controls.

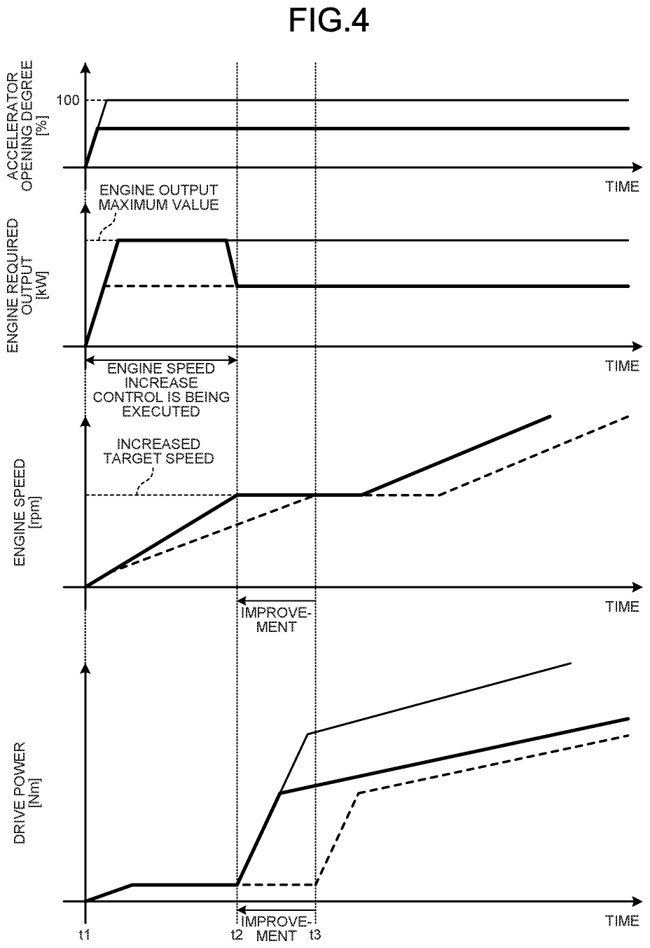

FIG. 4 is a time chart illustrating examples of accelerator opening degree, engine required output, engine speed Ne, and drive power. In FIG. 4, the thick solid line indicates acceleration (the embodiment)in which the accelerator is depressed halfway, the thick dotted line indicates acceleration (a conventional example) in which the accelerator is depressed halfway, and the thin line indicates acceleration in which the accelerator is fully open.

In the acceleration (the embodiment) in which the accelerator is depressed halfway, the engine speed increase control is started when there is a request for the engine speed increase control with the accelerator depressed halfway, at the time point t1, and when the engine speed Ne is lower than an increased target speed that is a predetermined value. Then, in the acceleration (the embodiment) in which the accelerator is depressed halfway, an engine required output is increased to the engine output maximum value from the time point t1 to the time point t2 as when the accelerator is fully open. In other words, when there is a request for the engine speed increase control with the accelerator depressed halfway, and when the engine speed Ne is lower than the predetermined value, an engine speed increase rate is maximized regardless of the accelerator opening degree.

Next, when the engine speed Ne reaches the increased target speed at the time point t2, the engine speed increase control is completed, and the engine required output is decreased to a magnitude corresponding to at least the accelerator opening degree. At this time, the engine required output is an engine required output determined by an accelerator opening degree+power corresponding to engine inertia or is an engine required output determined by an accelerator opening degree.

The reaction torque of the first motor generator 2 is output after the engine speed Ne is raised to the target speed.

Meanwhile, during the acceleration (the conventional example) with the accelerator depressed halfway, an engine required output is set to a value corresponding to an accelerator opening degree from the time point t1 at which the engine speed increase control is started to the time point t3 at which the engine speed increase control is completed. In other words, when there is a request for the engine speed increase control with the accelerator depressed halfway and when the engine speed Ne is lower than the predetermined value, the engine speed increase rate is smaller than that when the accelerator is fully open.

Therefore, as can be seen from FIG. 4, during the acceleration (the embodiment) in which the accelerator is depressed halfway, the engine speed increase control with the accelerator depressed halfway can be completed earlier than that during the acceleration (the conventional example) in which the accelerator is depressed halfway.

As described above, the hybrid vehicle Ve according to the present embodiment is a hybrid vehicle Ve in which the reaction torque of the first motor generator 2 is output when the engine speed Ne is equal to or higher than a predetermined value and, if the engine speed Ne is lower than the predetermined value, the engine speed increase rate is maximized regardless of the accelerator opening degree. Accordingly, in the hybrid vehicle Ve according to the present embodiment, the engine speed increase control with the accelerator depressed halfway can be completed earlier than the case where the engine speed increase rate with the accelerator depressed halfway is smaller than that with the accelerator fully open. Therefore, in the hybrid vehicle Ve according to the present embodiment, the first motor generator 2 can output the reaction torque and increase the drive power earlier than the case where the engine speed increase rate with the accelerator depressed halfway is smaller than that with the accelerator fully open. Thus, acceleration response (drive power output response) when the accelerator is depressed halfway can be improved.

It should be noted that whether to perform such control may be determined by determining whether the control need to be preformed or not, based on the driver's depression on the accelerator, travel history or the like.

In addition, in a system combined with an engine 1 including a supercharger 21, as in a hybrid vehicle Ve according to the present embodiment, the control described in the present embodiment is particularly effective because there is a need to increase the engine speed Ne quickly in order to rotate the turbine of the supercharger 21.

### INDUSTRIAL APPLICABILITY

According to the present invention, a hybrid vehicle that can improve acceleration response when an accelerator is depressed halfway.

### REFERENCE SIGN LIST

1 ENGINE
2 FIRST MOTOR GENERATOR
3 SECOND MOTOR GENERATOR
4 POWER DIVIDING MECHANISM
5 DRIVE SHAFT
6 DRIVE WHEEL
7 SUN GEAR
8 RING GEAR
9 CARRIER
12 FIRST DRIVE GEAR
20 ECU
21 SUPERCHARGER
Ve HYBRID VEHICLE

1. A hybrid vehicle, comprising:
an engine;
an output member that transmits drive power to a drive wheel;
a rotary electric machine; and
a power dividing mechanism which divides drive power output by the engine into a drive power for the output member and a drive power for the rotary electric machine and transmits thereto, wherein
the power dividing mechanism includes at least three rotary elements, which are an input element coupled to the engine, a reaction force element coupled to the rotary electric machine, and an output element coupled to the output member;
the rotary electric machine is configured such that, in order that a torque corresponding to required engine torque based on an acceleration request is applied to the drive wheel, a reaction torque corresponding to the required engine torque is output,
the reaction torque of the rotary electric machine is output when an engine speed is equal to or higher than a predetermined value, and
in the hybrid vehicle, when the engine speed is lower than the predetermined value, an engine speed increase rate is maximized regardless of an accelerator opening degree.

2. The hybrid vehicle according to claim 1, wherein
the engine is equipped with a supercharger and
the hybrid vehicle is configured to increase an output torque of the engine by actuating the supercharger.
